(19) United States
(12) Patent Application Publication
(10) Pub. No.: US 2017/0257899 A1
(43) Pub. Date: Sep. 7, 2017

(54) SMART SWITCH CONTROL SYSTEM AND METHOD FOR DEALING WITH DISCONNECTION SITUATION

(71) Applicant: LUXUL TECHNOLOGY INCORPORATION, New Taipei City (TW)

(72) Inventors: Cheng-Hung Pan, New Taipei City (TW); Perng-Fei Yuh, New Taipei City (TW); Shiun-Shang Chan, New Taipei City (TW)

(21) Appl. No.: 15/166,584

(22) Filed: May 27, 2016

(30) Foreign Application Priority Data
Mar. 7, 2016 (TW) 105106859

(51) Int. Cl. H04W 76/02

(52) U.S. Cl. CPC H04W 76/023; H04W 76/028; H04W 84/12

(57) ABSTRACT

A smart switch control method for dealing with disconnection situation, the method includes steps of: establishing a connection among a mobile device, a plurality of match switches and a commercial/consumer plug and play (CPnP) server via a wireless station; determining whether the match switches are disconnected from the CPnP server; showing a network name in each of the match switches for the mobile device to be capable of being connected with one of the match switches in a point-to-point manner via the network name when the connection between the match switches and the CPnP server via the wireless station is cut off; and connecting the match switches with the CPnP server automatically when the connection between the match switches and the CPnP server is recovered, and the mobile device monitoring and exchanging instant information from the match switches via the CPnP server.

### CROSS-REFERENCE TO RELATED APPLICATIONS

This application claims the benefit of Taiwan patent application No. 105106859, filed on Mar. 7, 2016, the disclosure of which is incorporated herein in its entirety by reference.

### BACKGROUND OF THE INVENTION

1. Field of the Invention

The present invention relates to a smart switch control system and method, and more particularly to a smart switch control system and method capable of dealing with disconnection situation.

2. Description of Related Art

Since economy grows so fast and many office constructions are built in urban areas, office space at each floor of the construction buildings or each of the offices requires lamps to provide illumination. Normally, it is common to see many lamps in one office at the same time. However, not everyone is familiar with the installation locations of the lamp switches and it is very inconvenient for people to find out where the lamp switch is in the darkness. In addition, the conventional lamps can provide light source with stable illumination, but the light source with stable illumination is not good enough when ambient luminance exists or the ambient luminance varies during day time and night time. Therefore, the power is wasted and the cost for the company is increased. Accordingly, the conventional smart switch control system can remotely control electronic devices (such as lamps and so on) and the electronic devices can be controlled at anytime and anywhere to mitigate the inconvenience in switching on or off the electronic devices.

As shown in FIG. 4, the conventional smart switch control system 40 includes a mobile device 41, a commercial/consumer plug and play (CPnP) server 42, a plurality of match switches 43 and a wireless station 44. By setting the CPnP server 42, the mobile device 41 may control the match switches 43 via the CPnP server 42. However, when the mobile device 41 performs any operations, the operations are required to be executed through the CPnP server 42. If Internet connection for the CPnP server 42 is cut off or the CPnP server is crashed, the match switches 43 are not connected with the CPnP server 42 via a Wifi adapter 431 or the mobile device 41 is not connected with the CPnP server 42. The conventional smart switch control system 40 loses its functions.

### SUMMARY OF THE INVENTION

According to the drawbacks of the conventional technique, an objective of the present invention is to provide a smart switch control method for dealing with disconnection situation to solve the problem that the smart switch control system is not connected from the CPnP server when the Internet connection fails.

In order to achieve the aforementioned objective, a smart switch control method for dealing with disconnection situation comprises steps of: establishing a connection among a mobile device, a plurality of match switches and a commercial/consumer plug and play (CPnP) server via a wireless station; determining whether the match switches are disconnected from the CPnP server; showing a network name in each of the match switches for the mobile device to be capable of being connected with one of the match switches in a point-to-point manner via the network name when the connection between the match switches and the CPnP server via the wireless station is cut off; and connecting the match switches with the CPnP server automatically when the connection between the match switches and the CPnP server is recovered, and the mobile device monitoring and exchanging instant information from the match switches via the CPnP server.

Another objective of the present invention is to provide a smart switch control system for dealing with disconnection situation. The mobile device still may control the match switches when the Internet connection for the smart switch control system fails.

In order to achieve the aforementioned objective, a smart switch control system for dealing with disconnection situation is provided herein and comprises a mobile device, a CPnP server, a wireless station and a plurality of match switches. The mobile device has a smart switch control interface. The mobile device is connected with the CPnP server via Internet. The wireless station is configured to be connected with the Internet. Each of the match switches includes a Wifi adapter, and the match switches are wirelessly connected with the wireless station so as to be connected with the CPnP server via the wireless adapter and the smart switch control interface of the mobile device. The mobile device exchanges instant information from and controlling the match switches via the CPnP server when the match switches are connected with the CPnP server. Each of the match switches shows a network name and the mobile device is connected with one of the match switches in a point-to-point manner when the match switches and the CPnP server are disconnected.

The smart switch control system and method for dealing with disconnection situation provide a solution when the Internet connection fails. The smart switch control system still can control the match switches when the Internet connection is cut off. The mobile device can be directly connected with one of the match switches, which is requested to be controlled, in a point-to-point manner without the CPnP server.

### BRIEF DESCRIPTION OF THE DRAWINGS

FIG. 1A and FIG. 1B are views of the smart switch control system for dealing with disconnection situation in the present invention;

FIG. 2A and FIG. 2B are views of the smart switch control system for dealing with disconnection situation in the present invention;

FIG. 3 is a flowchart of a smart switch control method in the present invention; and

FIG. 4 is a view of a conventional smart switch control system.

### DETAILED DESCRIPTION OF THE PREFERRED EMBODIMENT

These and other aspects of the embodiments herein will be better appreciated and understood when considered in conjunction with the following description and the accompanying drawings.

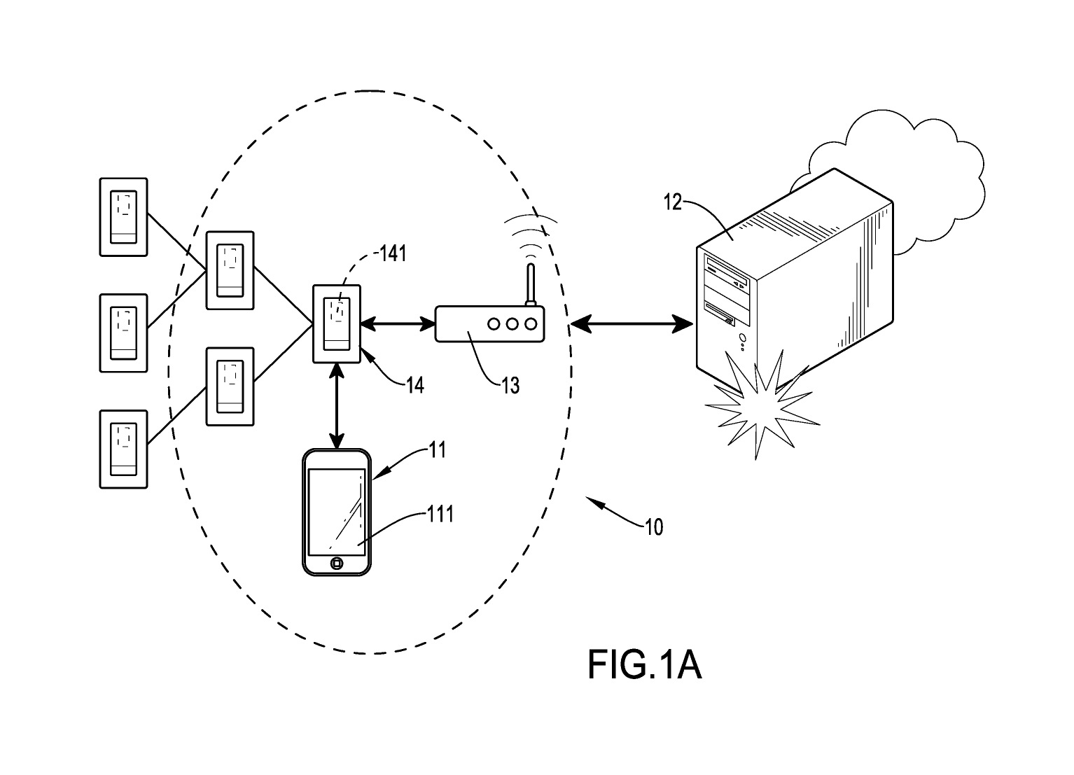

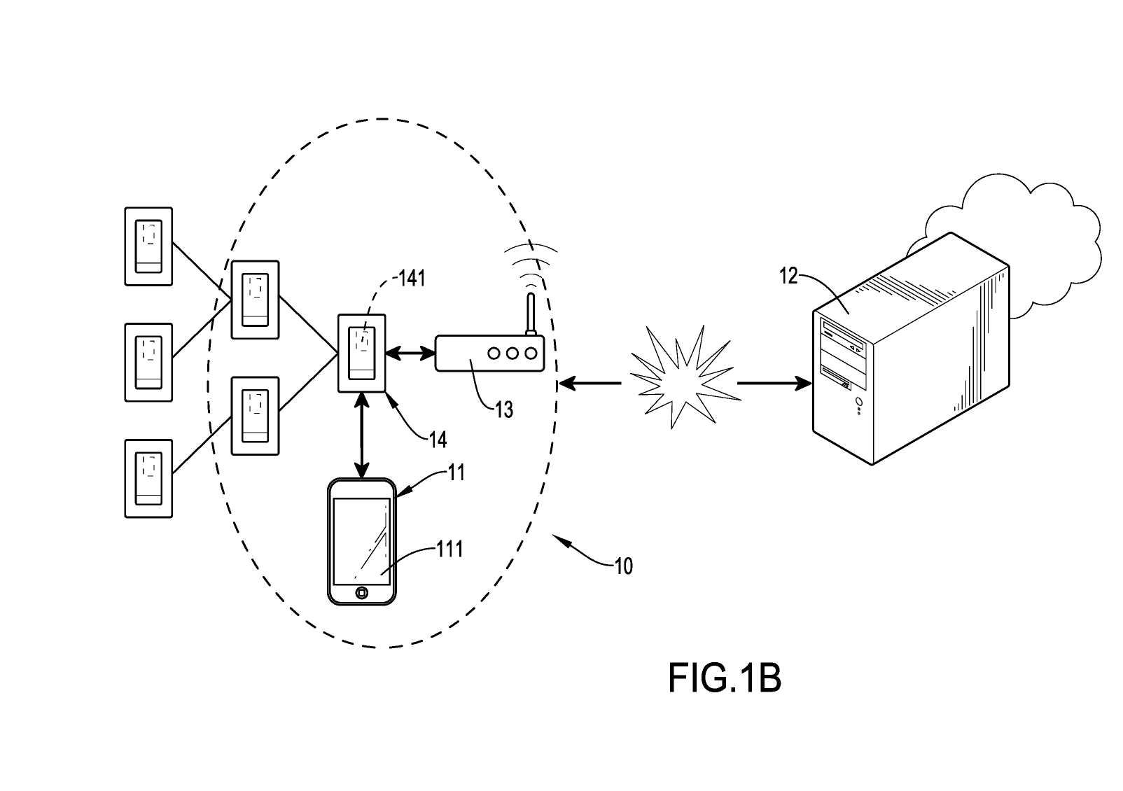

FIG. 1A and FIG. 1B are views of the smart switch control system for dealing with disconnection situation in the present invention. The smart switch control system 10 in the present invention includes a mobile device 11, a Commercial/Consumer Plug and Play (CPnP) server 12, a wireless station 13, and a plurality of match switches 14.

The mobile device 11 may be a smart phone, a tablet or a laptop, and it is not limited herein. The mobile device 11 is connected with Internet via 3G/4G telecommunication technique or the wireless station 13, so the mobile device 11 may be connected with the CPnP server 12 via the Internet. Each one of the match switches 14 includes a Wifi adapter 141 and is wirelessly connected with the wireless station 13 so as to be connected with the Internet via the Wifi adapter 141 and the smart switch control interface 111 of the mobile device 11. Therefore, the match switches 14 are connected with the CPnP server 12 via the Internet. When the mobile device 11 and the match switches 14 are connected with the CPnP server 12, match data for establishing a relationship between the mobile device 11 and the match switches 14 is developed in the CPnP server 12. For example, the match data is register data of the mobile device 11 and a code of the match switch 14. The register data of the mobile device 11 and the code of the match switches 14 are uploaded to the CPnP server 12 to finish a registration and a match by a user operation. Therefore, the mobile device 11 may control the match switches 14 via the CPnP server 12 in accordance with the match data.

When the CPnP server 12 is crashed (as shown in FIG. 1A) or the wireless station 13 is not connected with the Internet (as shown in FIG. 1B), the match switches 14 and the CPnP server 12 are disconnected and the match switches 14 fail to receive any network packets from the CPnP server 12. Whether the match switches 14 are connected with the CPnP server 12 or not can be determined by analyzing the network packets. The analysis of the network packets is well known for the person having ordinary skill in the art and the detail description thereof is omitted herein. At this moment, each of the match switches 14 will automatically show a network name (Service Set Identifier (SSID)) by the Wifi adapter 141 and determines if the CPnP server 12 is connectable or not. When the mobile device 11 detects the network name of the match switches 14, the mobile device 11 is connected with one of the match switches 14 in a point-to-point manner. The mobile device 11 is connected with the match switches 14 via the network name of the match switches 14. Therefore, the mobile device 11 can perform some operations, such as turning on/off, adjusting luminance and so on, without the CPnP server. When the match switches 14 determine that the CPnP server is connectable, it is represented that the Internet connection is available and the crash of the CPnP server has been overcome. The match switches 14 are automatically connected with the CPnP server 12 and the match switches 14 will automatically hide the network names and terminate the direct connection between the mobile device 11 and the match switch 14. Therefore, the mobile device 11 controls the match switches 14 via the CPnP server 12.

According to the aforementioned smart switch control system 10 for dealing with disconnection situation, the user can implement the mobile device 11 to control the match switches 14 to perform some operations, such as turning on/off and so on, in the electronic devices (such as lamps and etc) when the Internet connection is cut off or the CPnP server is crashed. The inconvenience that the user may not control the match switches 14 when the Internet connection fails or the CPnP server is crashed may be avoided.

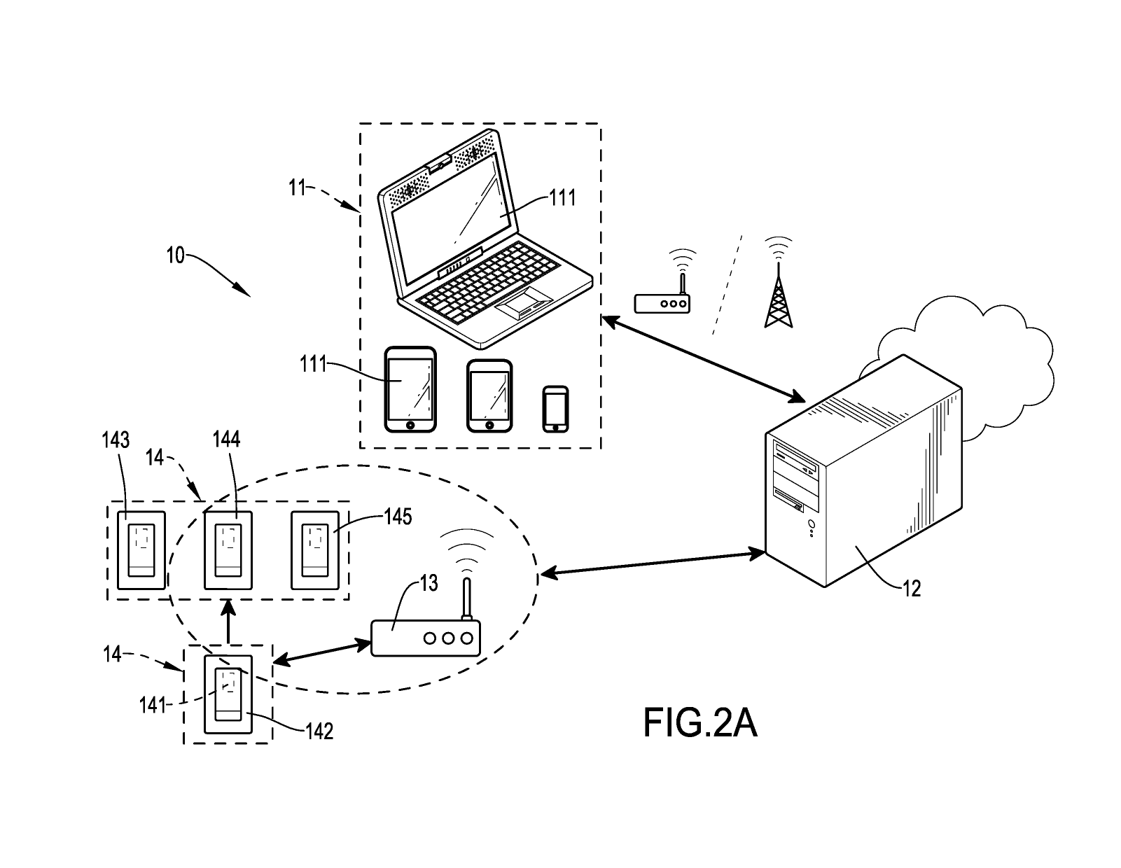

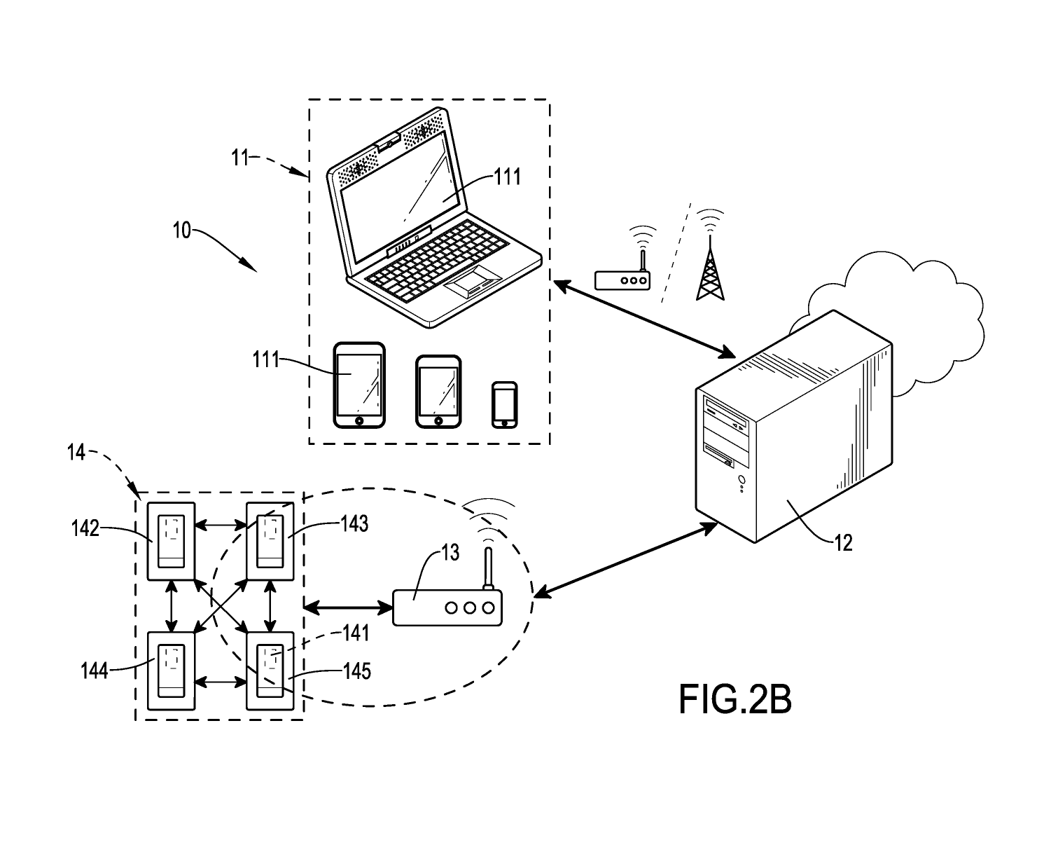

In addition, when the mobile device 11 and the match switches 14 are connected with the CPnP server 12, the smart switch control interface 111 of the mobile device 11 is used to set up some functions for each of the match switches 14. For example, as shown in FIG. 2A, in a single binding mode, the mobile device 11 may configure to set one of the match switches 14 (such as a first match switch 142) to have a control permission among a first match switch 142, a second match switch 143, a third match switch 144, and a fourth match switch 145. Specifically, the first match switch 142, the second match switch 143, the third match switch 144 and the fourth match switch 145 are corresponding to the same one electronic device and only the first match switch 142 has the control permission to operate the electronic device at the time. Moreover, as shown in FIG. 2B, in a multiple binding mode, the mobile device 11 may configure to set at least two of the match switches 14 to have the control permission. For example, the first match switch 142, the second match switch 143, the third match switch 144, and the fourth match switch 145 are corresponding to the same one electronic device (such the lamp, etc.) and the first match switch 142, the second match switch 143, the third match switch 144, and the fourth match switch 145 are respectively located at different positions. The user may use the first match switch 142 to turn on the electronic device and use the third match switch 144 to turn off the electronic device. By the aforementioned setting, the operation of the match switches 14 by the smart switch control system 10 in the present invention is more flexible. However, in the disconnection mode, the mobile device 11 may include a complete operation, such as turning on/off or adjusting luminance and so on, for the connected match switches 14 and the mobile device 11 do not include the operation of multiple binding or single binding, for the match switches 14. The mobile device 11 only can control the match switches 14 individually.

It should be noted that the smart switch control interface 111 may be application software in the mobile device 11. When the user opens the smart switch control interface 111 in the mobile device 11, the smart switch control interface 111 will show whether the CPnP server 12 is connected or not in the smart switch control system 10 and also show the connection status of the match switches 14. The smart switch control interface 111 includes functions such as controlling the match switches 14 and so on. However, the design of the display and the operation capabilities in the smart switch control interface 111 is well known for the person having ordinary skill in the art, such as software design, computer science and so on, and the description regarding how to develop and design the smart switch control interface 111 is omitted herein.

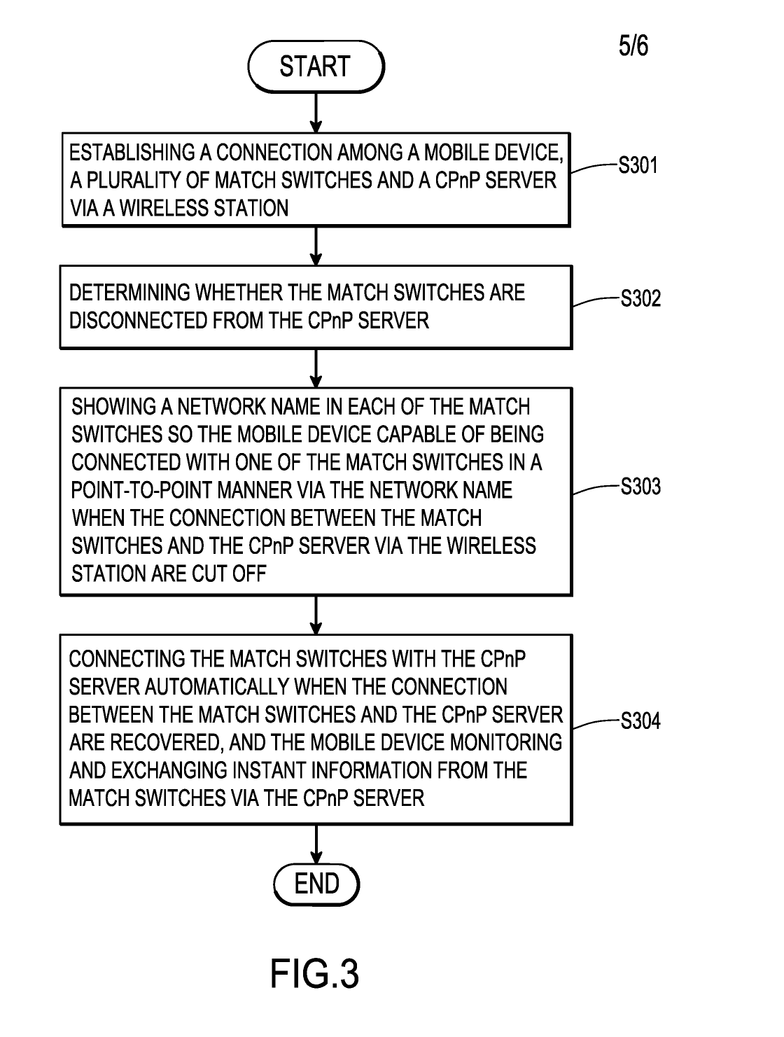

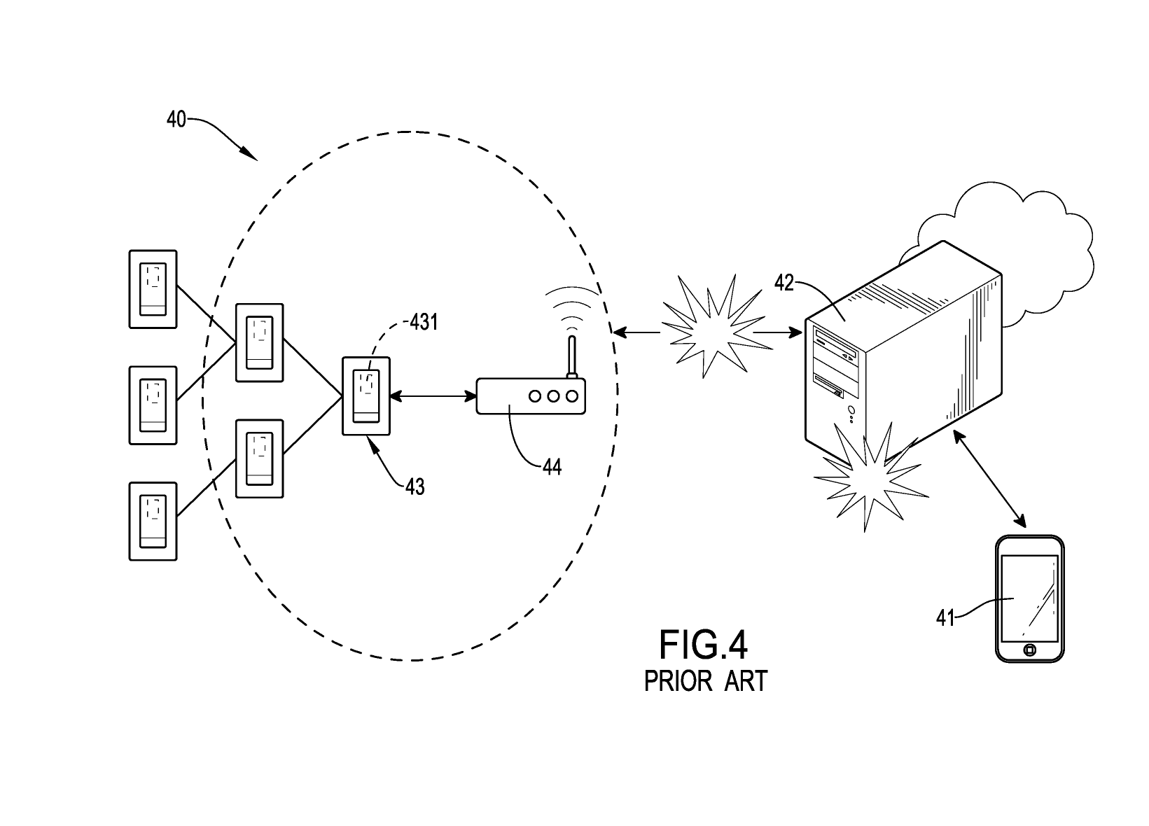

FIG. 3 is a flowchart of a smart switch control method in the present invention. As shown in FIG. 3, in step S301, the connection among the mobile device, the match switches and the CPnP server is established. When the mobile device 11 and the match switches 14 are connected with the CPnP server 12, the transmission of the Internet is normal and the CPnP server 12 is also functional. The instant information and the controlling information are normally exchanged between the mobile device 11 and the match switches 14 via the CPnP server 12. In step S302, the match switches 14 determine whether the disconnection between the match switches 14 and the CPnP server 12 occurs. When the match switches 14 and the CPnP server 12 are disconnected, the match switches 14 do not receive any network packets from the CPnP server 12 and the match switches 14 determine that the connection between the match switches 14 and the CPnP server 12 is terminated. The reason for the disconnection between the match switches 14 and the CPnP server 12 may be the disconnection of the Internet, the crash of the CPnP server 12 or the crash of the wireless station 13. As long as the match switches 14 does not receive or transmit the network packets of the CPnP server 12, the disconnection between the match switches 14 and the CPnP server 12 are determined. In step S303, when the match switches and the CPnP server are disconnected, each of the match switches 14 shows a network name for the mobile device to connect with the match switches 14 in the point-to-point manner. When the match switches 14 and the CPnP server 12 are disconnected, each of the match switches 14 shows the hidden network name for the mobile device 11 to see. Therefore, the match switches 14 are respectively and individually connected with the mobile device 11 in the point-to-point manner. In the point-to-point manner, the mobile device 11 may perform some simple operations, such as turning on/off, to the match switches 14. When the match switches 14 show the network name, the match switches 14 still keep tracking whether the connection with the CPnP server is available or not.

In step S304, when the connection for the match switches 14 and the CPnP server 12 is available, the match switches 14 are automatically connected with the CPnP server 12 and the mobile device 11 exchanges instant information with the match switches 14 via the CPnP server 12. In step S305, when the match switches 14 may receive the network packets from the CPnP server 12 and the connection between the match switches 14 and the CPnP server 12 is recovered, the mobile device 11 exchanges the instant information and the controlling information with the match switches 14 via the CPnP server 12 and all the information transmitted between the mobile device 11 and the match switch 14 is through the CPnP server 12. The CPnP server encrypts instant information by D5 (Message Digest 5) or AES 256 (Advance Encryption Standard 256) when the match switches are connected with the CPnP server.

The smart switch control system and method in the present invention may be used to overcome the drawback that the mobile device fails to control the match switches when the Internet is disconnected or the CPnP server is crashed in the conventional smart switch control system. The mobile device is directly connected with one of the match switches, which is requested to be controlled, in the point-to-point manner without the CPnP server.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A smart switch control method for dealing with disconnection situation, the method comprising steps of:
establishing a connection among a mobile device, a plurality of match switches, and a commercial/consumer plug and play (CPnP) server via a wireless station;
determining whether the match switches are disconnected from the CPnP server;
showing a network name in each of the match switches for the mobile device to be capable of being connected with one of the match switches in a point-to-point manner via the network name when the connection between the match switches and the CPnP server via the wireless station is cut off; and
connecting the match switches with the CPnP server automatically when the connection between the match switches and the CPnP server is recovered, and the mobile device monitoring and exchanging instant information from the match switches via the CPnP server.

2. The smart switch control method as claimed in claim 1, wherein each of the match switches includes a Wifi adapter and shows the network name via the Wifi adapter.

3. The smart switch control method as claimed in claim 1, wherein the network name is a Service Set Identifier (SSID).

4. The smart switch control method as claimed in claim 1, wherein the CPnP server encrypts the instant information by D5 (Message Digest 5) or AES 256 (Advance Encryption Standard 256) when the match switches are connected with the CPnP server.

5. The smart switch control method as claimed in claim 1, wherein the match switches automatically hide the network name when the match switches are connected with the CPnP server.

6. A smart switch control system for dealing with disconnection situation, comprising:
a mobile device having a smart switch control interface;
a CPnP server connected with the mobile device via Internet;
a wireless station configured to be connected with the Internet; and
a plurality of match switches and each of the match switches having a Wifi adapter, and the match switches wirelessly connected with the wireless station so as to be connected with the CPnP server via the wireless adapters and the smart switch control interface of the mobile device;
wherein the mobile device exchanges instant information and controlling information with the match switches via the CPnP server when the match switches are connected with the CPnP server;
each of the match switches shows a network name and the mobile device is connected with one of the match switches in a point-to-point manner when the match switches are disconnected from the CPnP server.

7. The smart switch control system as claimed in claim 6, wherein the network name is a Service Set Identifier (SSID).

8. The smart switch control system as claimed in claim 6, wherein the CPnP server encrypts the instant information and controlling information by D5 (Message Digest 5) or AES 256 (Advance Encryption Standard 256) when the match switches are connected with the CPnP server.

9. The smart switch control system as claimed in claim 6, wherein the match switches hide the network name when the match switches are connected with the CPnP server and the match switches show the network name when the match switches disconnect the CPnP server.

10. The smart switch control system as claimed in claim 6, wherein the mobile device sets at least one of the match switches to have a controlling permission when the match switches connect with the CPnP server.
